(19) United States
(12) Patent Application Publication
(10) Pub. No.: US 2016/0082616 A1
(43) Pub. Date: Mar. 24, 2016

(54) ADJUSTABLE ANGLE PLANER TABLE

(71) Applicant: Thomas Lee Whitaker, Seattle, WA (US)

(72) Inventor: Thomas Lee Whitaker, Seattle, WA (US)

(21) Appl. No.: 14/494,398

(22) Filed: Sep. 23, 2014

(51) Int. Cl. B27C 1/12

(52) U.S. Cl. CPC B27C 1/12

(57) ABSTRACT

An adjustable angle planer table for use with a conventional wood planer machine comprises a base plate and a tilting table. The base plate includes a flat attachment surface for securing the base plate to the bed of a planer and an arcuate sliding surface for receiving the tilting table. The tilting table includes flat table surface for feeding a board through the planer and an arcuate adjustment surface for slidably engaging the sliding surface. The base plate attaches to the bed of a planer and the tilting table is positioned on the base plate with its table surface at a desired angle and locked in place. Then, with the tilting table locked in place a board can be fed through the planer at the selected angle, resulting in the board's opposite face to be trimmed flat, but on a non-parallel plane with respect to the reference face.

### BRIEF DESCRIPTION OF THE DRAWINGS

FIG. 1 is a side elevation view of an adjustable angle planer table built in accordance with an embodiment of the present invention in a level position.

FIG. 2 is a side elevation view of an adjustable angle planer table built in accordance with an embodiment of the present invention in an angled position.

FIG. 3A is a perspective view of the base plate of an adjustable angle planer table built in accordance with the present invention.

FIG. 3B is a side cross section view of the base plate of an adjustable angle planer table built in accordance with the present invention.

FIG. 3C is a top plan view of the base plate of an adjustable angle planer table built in accordance with the present invention.

FIG. 4A is a perspective view of the tilting table of an adjustable angle planer table built in accordance with the present invention.

FIG. 4B is a side cross section view of the tilting table of an adjustable angle planer table built in accordance with the present invention.

FIG. 4C is a top plan view of the tilting table of an adjustable angle planer table built in accordance with the present invention.

### DETAILED DESCRIPTION OF THE INVENTION

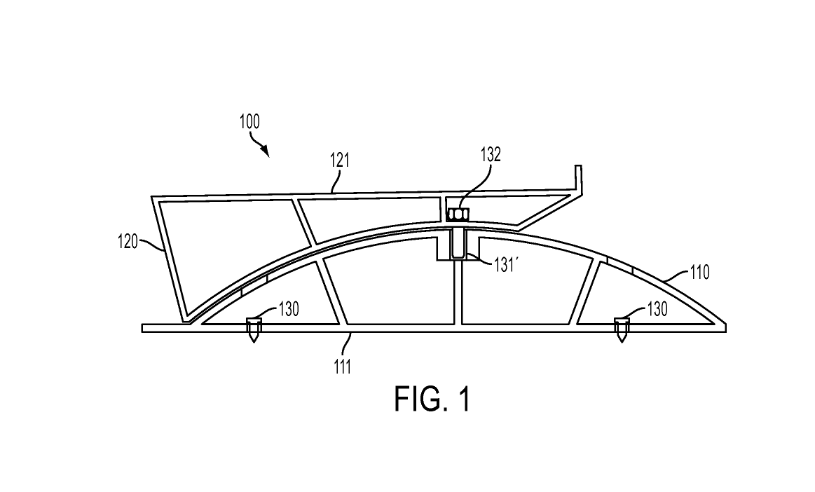

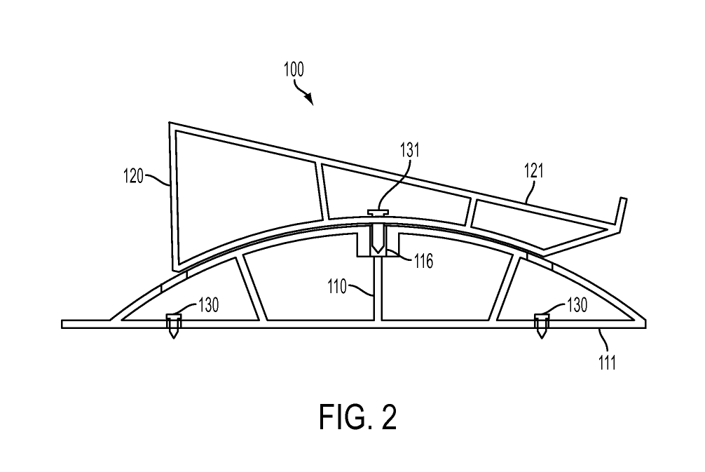

Referring now to the drawings and in particular FIGS. 1 and 2, an adjustable angle planer table 100 for attaching to the bed of a conventional wood planer machine (or “planer,” “thickness planer”) is shown as a base plate 110 having a tilting table 120 slidably disposed thereon. Typically, when a board having a reference face and an opposing non-reference face (or “opposite face”) is fed through a conventional planer, material is removed from the opposite face by a cutter head, thereby flattening it and always making it parallel to the reference face. When the adjustable angle planer table 100 is in place on a planer (not shown), it provides an adjustable, locking surface that causes a board being fed through the planer to be held at a selected angle, resulting in the board's opposite face to be trimmed flat, but on a non-parallel plane with respect to the reference face. In this regard, the adjustable angle planer table 100 provides an attachment to a planer that, with the otherwise normal operation of the planer, enables the creation of a board that is flat on both sides but has an increasing (or decreasing, depending on the perspective) thickness.

In the preferred embodiment, the base plate 110 and tilting table 120 each define aluminum extrusions cut to thirty six (36) inches in length. In alternate embodiments, however, it is contemplated that, a base plate 110 and tilting table 120 built in accordance with the present invention may define an extrusion and/or a molding of alternate rigid materials, including other metals or plastic. In addition, a base plate 110 and tilting table 120 in accordance with the present invention may be sized to another length suitable for attachment to the bed of a wood planer which may be greater than or less than thirty six (36) inches.

The adjustable angle planer table 100 is shown in FIG. 1 in a flat, first position defined by the positioning of the tilting table 120 on the base plate 110 such that the plane of its table surface 121 is parallel to the plane of an attachment surface 111 of the base plate 110. It is contemplated that when the adjustable angle planer table 100 is in place on a planer, the attachment surface 111 will lay on top of the planer bed, flush therewith, the first position embodies the tilting table 120 being set at a zero (0) degree angle in which the adjustable angle planer table 100 would feed a board through the planer in the typical manner (making the opposite side parallel with the reference side.

The adjustable angle planer table 100 is shown in FIG. 2 in an angled, second position defined by the positioning of the tilting table 120 on the base plate 110 such that the plane of its table surface 121 is not parallel to an attachment surface 111 of the base plate 110. In the second position, the tilting table 120 is set at an acute angle relative to the attachment surface 111 and the bed of the planer. Consequently, a board on the table surface 121 in the second position would be fed through the planer at the selected angle which defines the second position, resulting in the board's opposite face to be trimmed flat, but not parallel to the reference face.

In the preferred embodiment, it is contemplated that the tilting table 120 can be set at any angle between zero (0) and thirty (30) degrees.

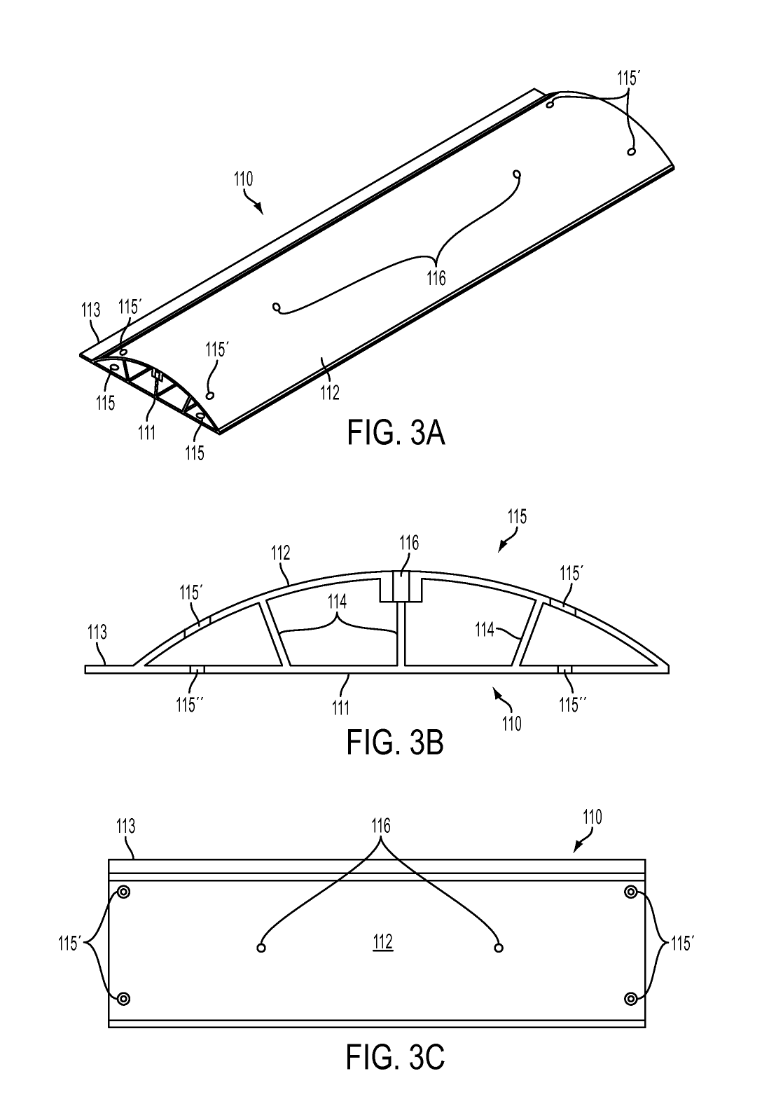

Referring now to FIGS. 1, 2, 3A, 3B, and 3C, the base plate 110 is shown having a flat attachment surface 111 and an arcuate sliding surface 112. The arcuate sliding surface 112 is disposed over the flat attachment surface 111 and is sized such that the sliding surface 112 and attachment surface 111 share the same outermost edge on one side and the attachment surface 111 extends beyond the edge of the sliding surface 112 on the other end, defining a stopper lip 113.

While the internal area of the base plate 110 between the attachment surface 111 and the sliding surface 112 is substantially hollow, it includes three internal support beams 114 that provide supplementary structural support (supplementing the areas where the attachment surface 111 and the sliding surface 112 meet) without substantially increasing the weight of the base plate 110.

The base plate 110 includes four mounting tunnels 115′, 115″ (collectively, 115), each defined by a pair of corresponding apertures, specifically an attachment surface mounting aperture 115″ and a sliding surface mounting aperture 115′. For each mounting tunnel 115, the attachment surface mounting aperture 115″ and sliding surface mounting aperture 115′ are aligned such that an attachment stud 130 passing through the attachment surface mounting aperture 115″ to engage a hole in the planer bed can be accessed by a fastening tool (such as a conventional screwdriver with an elongated handle). Accordingly, in the preferred embodiment, the attachment stud 130 is threaded and is employed to pass through the attachment surface mounting aperture 115″ and engage in a hole on the planer bed, thereby fastening the base plate 110 to the planer bed.

In the embodiment illustrated in FIG. 2, the base plate 110 additionally includes two threaded adjustment apertures 116 in the sliding surface 112. Each adjustment apertures 116 is sized to receive an adjustment stud 131 that, when it is desired to fix the tilting table 120 at a specific angle, can be inserted through adjustment slots in the tilting table 120 to engage and fasten in the adjustment apertures 116. As will be discussed below, this action enables the fastening of the tilting table 120 to the base plate 110 in a set place (and at a set angle).

In the embodiment illustrated in FIG. 1, the base plate 110 additionally includes two threaded adjustment studs 131′ integrated into the sliding surface 112 in place of the adjustment apertures. The integrated adjustment studs 131′ are sized to receive a threaded nut 132 that, when it is desired to fix the tilting table 120 at a specific angle, can be inserted through adjustment slots in the tilting table 120 and tightened on the adjustment studs to hold the tilting table 120 in place. As will be discussed below, this action provides a alternative mechanism for fastening of the tilting table 120 to the base plate 110 in a set place (and at a set angle).

In the preferred embodiment, the adjustment apertures 116 have been machined to receive and engage an adjustment stud 131 that is threaded.

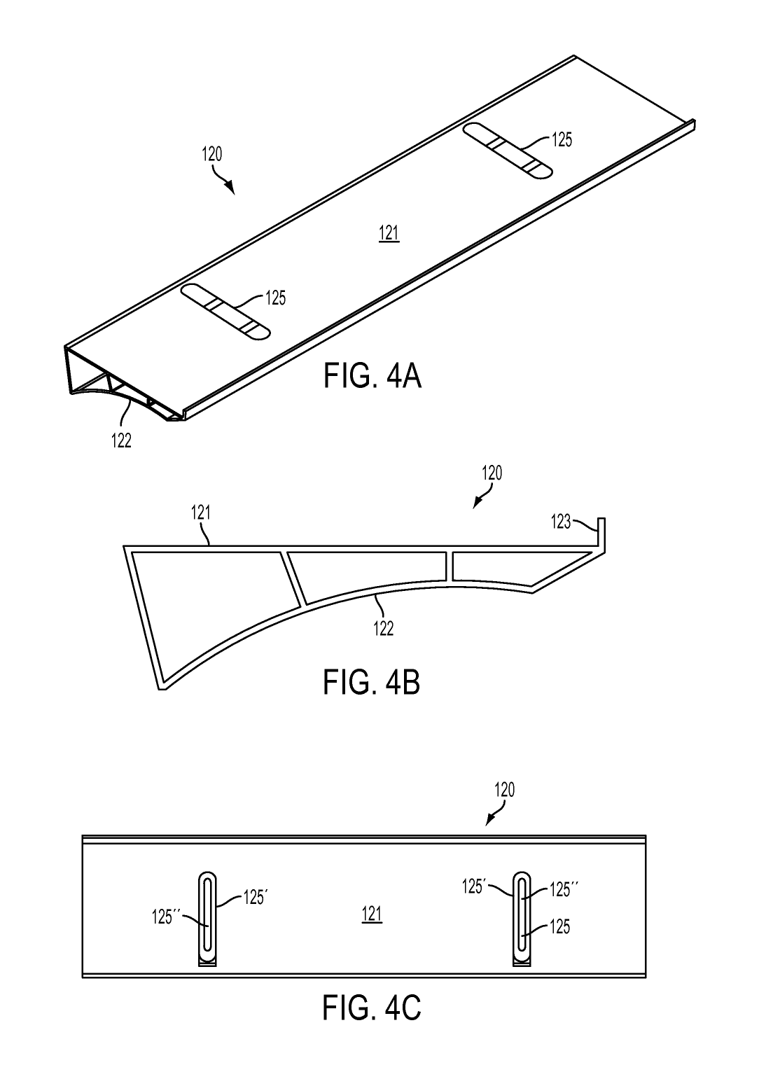

Referring now to FIGS. 1, 2, 4A, 4B, and 4C, the tilting table 120 is shown having a flat table surface 121 and an arcuate adjustment surface 122. The table surface 121 is disposed over the adjustment surface 122 and is sized with its longitudinal sides extending slightly beyond those of the adjustment surface 122 at both ends. At one longitudinal side, the table surface includes a retaining lip 123 that extends upward from the table surface 121 in a perpendicular orientation relative thereto.

Connecting the table surface 121 and the adjustment surface 122 are four table beams 124 that provide structural support without substantially increasing the weight of the tilting table 120. The remainder of internal area of the tilting table 120, however, between the table surface 121 and the adjustment surface 122, is substantially hollow so as obtain the benefits of reduced material requirements and weight.

The tilting table 120 includes two adjustment slots 125 which each form an elongated passageway through the entire tilting table 120. As with the adjustment apertures of the base plate, the adjustment slots 125 are each sized to receive the adjustment stud 131 that, when it is desired to fix the tilting table 120 at a specific angle on the base plate 110, is inserted through the adjustment slots 125, engaging the adjustment apertures in which it can be fastened. To facilitate insertion and removal of the adjustment studs 131 while also allowing them to securely fasten the tilting table 120, the first adjustment slot opening 125′, in table surface 121, is wider than the second adjustment slot opening 125″ in the adjustment surface 122.

Referring now to FIGS. 1, 2, 3A, 3B, 3C, 4A, 4B, and 4C, in one embodiment, the integrated adjustment studs 131′ are permanently mounted in the base plate 110 at the location of the adjustment apertures 116 so that the integrated adjustment studs 131′ protrude through the adjustment slot opening 125″. When it is desired to fix the tilting table 120 at a specific angle on the base plate 110, threaded nuts 132 are placed on the integrated adjustment studs 131′ as they protrude through the adjustment slot opening 125″ and tightened to compress the adjustment surface 122 against the sliding surface 112, thereby holding the tilting table 120 at the set angle on the base plate 110. It is contemplated that such an embodiment will minimize potential wear on the adjustment apertures 116.

It is contemplated that the arc of the adjustment surface 122 and that of the sliding surface 112 define complementary arcs, so as to allow the entire adjustment surface 122 to contact the sliding surface 112 at all times when the tilting table 120 is in place on the base plate 110. Such complementary arcs additionally enable the adjustment surface 122 to be slid over the sliding surface 112 when it is desired to adjust the angle of the table surface 121.

In the preferred embodiment, the adjustable angle planer table 100 is used by first securing the base plate 110 to the bed of a planer through the use of the attachment studs 130 that pass through each mounting tunnel 115 and fasten to holes in the planer bed. It is understood, however, alternate manners of securing the base plate 110 to the planer bed may be employed, including an alternate fastener or an adhesive.

Next, the tilting table 120 is placed on the base plate 110, with the adjustment slot 125 each disposed over an adjustment aperture 116 so that threaded adjustment studs 131 can be inserted through each adjustment slots 125 into a corresponding adjustment aperture 116. Generally, the adjustment studs 131 will be partially screwed in while the tilting table 120 is positioned so that the table surface 121 is at the desired angle. Once the tilting surface is at the desired angle, the adjustment studs 131 are fully screwed in, with head of the adjustment screw against the second adjustment slot opening 125″, holding it against the sliding surface 112.

In one embodiment, the adjustable angle planer table 100 includes injection molded polymer degree and vernier scales (not shown) adhesively attached at one end of the paired base plate 110 and tilting table 120 to allow the precise measurement of the present angle at which the tilting table 120 is set.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. An adjustable angle planer table for use in the bed of a conventional planer, comprising:
a base plate having an attachment surface configured to be secured to the bed of a planer and a sliding surface;
a tilting table having a table surface on which a board can be fed through a planer and an adjustment surface; and
wherein the tilting table is disposed on the base plate with the adjustment surface contacting the sliding surface.

2. The adjustable angle planer table for use in the bed of a conventional planer of claim 1, wherein the entire adjustment surface contacts the sliding surface when the tilting table is on the base plate.

3. The adjustable angle planer table for use in the bed of a conventional planer of claim 1, wherein the adjustment surface and the sliding surface define complementary arcuate surfaces.

4. The adjustable angle planer table for use in the bed of a conventional planer of claim 1, wherein said base plate additionally includes a stopper lip disposed on one of the longitudinal sides of the attachment surface.

5. The adjustable angle planer table for use in the bed of a conventional planer of claim 1, wherein said tilting table additionally includes a retaining lip that extends upward there from.

6. The adjustable angle planer table for use in the bed of a conventional planer of claim 1, wherein the base plate additionally includes a plurality of mounting tunnels, each defined by an attachment surface mounting aperture and a sliding surface mounting aperture and adapted to receive an attachment stud for securing the base plate to the bed of a planer.

7. The adjustable angle planer table for use in the bed of a conventional planer of claim 1, wherein:
the base plate additionally includes in the sliding surface at least one adjustment aperture that is adapted to receive an adjustment stud for securing the tilting table to the base plate; and
the tilting table additionally includes at least one adjustment slot positioned to correspond to the at least one adjustment aperture in the base plate and adapted to have the adjustment stud that secures the tilting table to the base plate pass there through.

8. The adjustable angle planer table for use in the bed of a conventional planer of claim 1, wherein:
the base plate additionally includes in the sliding surface at least one adjustment stud integrated therein; and
the tilting table additionally includes at least one adjustment slot positioned to correspond to the at least one adjustment stud in the base plate such that the adjustment stud passes through it when the tilting table is on the base plate.

9. The adjustable angle planer table for use in the bed of a conventional planer of claim 1, wherein the tilting table additionally includes at least one adjustment slot adapted to have an adjustment stud for securing the tilting table to the base plate pass there through.

10. The adjustable angle planer table for use in the bed of a conventional planer of claim 1, wherein the base plate and the tilting table are constructed of extruded aluminum, said base plate is structured with only a plurality of internal support beams between the attachment surface and the sliding surface, and said tilting table is structured with only a plurality of table beams between the table surface and the adjustment surface.

11. A method of feeding a board through the bed of a conventional planer on a nonparallel plane to the reference side, comprising the steps of:
securing a base plate having an attachment surface and a sliding surface, wherein the attachment surface is configured to be secured to the bed of a planer;
attaching a tilting table having a table surface on which a board can be fed through a planer and an adjustment surface to the base plate with the adjustment surface contacting the sliding surface and the plane of the table surface at a nonparallel angle relative to the attachment surface; and
feeding a board with its reference side on the tilting table through a planer having the base plate attached thereto.

12. The method of claim 1, wherein the entire adjustment surface contacts the sliding surface when the tilting table is on the base plate.

13. The method of claim 1, wherein the adjustment surface and the sliding surface define complementary arcuate surfaces.

14. The method of claim 1, wherein said base plate additionally includes a stopper lip disposed on one of the longitudinal sides of the attachment surface.

15. The method of claim 1, wherein said tilting table additionally includes a retaining lip that extends upward therefrom.

16. The method of claim 1, wherein the base plate additionally includes a plurality of mounting tunnels, each defined by an attachment surface mounting aperture and a sliding surface mounting aperture adapted to receive an attachment stud for securing the base plate to the bed of a planer, and the step of securing includes passing the attachment stud through the mounting tunnels into the bed of a planer.

17. The method of claim 1, wherein:
the base plate additionally includes in the sliding surface at least one adjustment aperture that is adapted to receive an adjustment stud for attaching the tilting table to the base plate; and
the tilting table additionally includes at least one adjustment slot positioned to correspond to the at least one adjustment aperture in the base plate and adapted to have the adjustment stud that secures the tilting table to the base plate pass there through and the step of attaching includes passing the adjustment stud through the adjustment slot and into the adjustment aperture.

18. The method of claim 1, wherein:
the base plate additionally includes in the sliding surface at least one adjustment stud integrated therein; and
the tilting table additionally includes at least one adjustment slot positioned to correspond to the at least one adjustment stud in the base plate such that the adjustment stud passes through it when the tilting table is on the base plate and the step of attaching includes passing the adjustment stud through the adjustment slot.

19. The method of claim 1, wherein the tilting table additionally includes at least one adjustment slot adapted to have an adjustment stud for securing the tilting table to the base plate pass there through and the step of attaching includes passing the adjustment stud through the adjustment slot.

20. The method of claim 1, wherein the base plate and the tilting table are constructed of extruded aluminum, said base plate is structured with only a plurality of internal support beams between the attachment surface and the sliding surface, and said tilting table is structured with only a plurality of table beams between the table surface and the adjustment surface.
